(19) United States
(12) Patent Application Publication
(10) Pub. No.: US 2024/0247439 A1
(43) Pub. Date: Jul. 25, 2024

(54) SCALE INHIBITION FOR PULP DIGESTERS

(71) Applicant: Ecolab USA Inc., St. Paul, MN (US)

(72) Inventors: John Matthew CHUDOMEL, Aurora, IL (US); Jeffery Mark ATKINS, Aurora, IL (US); Dorota SMORON, Bartlett, IL (US); Prasad Yogendra DUGGIRALA, Naperville, IL (US); Peter E. REED, Plainfield, IL (US)

(73) Assignee: Ecolab USA Inc., St. Paul, MN (US)

(21) Appl. No.: 18/410,674

(22) Filed: Jan. 11, 2024

Related U.S. Application Data
(60) Provisional application No. 63/480,856, filed on Jan. 20, 2023.

(51) Int. Cl. D21C 3/22; C08F 220/06; C08F 222/06; D21C 9/10; D21C 9/18; D21C 11/00

(52) U.S. Cl. CPC D21C 3/226; C08F 220/06; C08F 222/06; D21C 9/1026; D21C 9/18; D21C 11/0085; C08F 2800/10

(57) ABSTRACT

Methods and compositions for inhibiting scale in papermaking processes are provided. The methods may include adding an effective amount of a terpolymer composition to an aqueous medium in the papermaking process. The terpolymer may include various monomers, such as maleic anhydride, acrylic acid, and methacrylic acid. As non-limiting example, the weight average molecular weight of the terpolymer may be from about 5,000 Da to about 20,000 Da.

### BACKGROUND

Scale buildup during pulp processing contributes to lost pulp mill productivity. Scale deposition can occur on heaters and extraction screens of continuous digesters and on heat-transfer surfaces in evaporators where the liquor is processed. A common source of scale buildup is calcium carbonate (CaCO₃), which can reduce efficiency and increase cost in the manufacturing process, including by increasing the usage of steam due to scaling on heat exchange surfaces and reduced production of strong black liquor as well as reduced flow rates, fluctuating kappa numbers, and carryover of pulping chemicals.

In some instances, scale is removed using acid cleaning, which adds cost, personnel usage, and increased disposal as well as additional wear on process equipment. In other instances, scale can be removed by cleaning with ethylenediamine tetraacetic acid (EDTA) or by mechanical methods, such as steam shock and hydroblasts.

### BRIEF SUMMARY

The present disclosure provides compositions and methods for inhibiting calcium carbonate scaling during papermaking processes.

In some embodiments, a method is provided for inhibiting calcium carbonate scale in a papermaking process, which can include adding an effective amount of a composition comprising a terpolymer to an aqueous medium in the papermaking process, wherein the terpolymer has a weight average molecular weight of about 5,000 Da to about 20,000 Da, further wherein the terpolymer comprises a first monomer, a second monomer, and a third monomer, wherein the first monomer comprises methacrylic acid; and inhibiting calcium carbonate scale in the papermaking process.

In some embodiments, the second and third monomers are independently selected from the group consisting of an alkyl acrylic acid, a butenoic acid, such as crotonic acid, a pentenoic acid, a propenoic acid, an unsaturated monocarboxylic acid capable of polymerizing, a dicarboxylic acid, maleic anhydride, maleic acid, monosodium maleate, disodium maleate, fumaric acid, itaconic acid, glutaconic acid, muconic acid, succinic acid, an unsaturated dicarboxylic acid, an anhydride of an unsaturated dicarboxylic acid capable of polymerizing, a compound containing three or more carboxylic acid groups, such as citric acid, aconitic acid, a monomer comprising a carboxyl moiety, a salt of any of the foregoing, a conjugate base of any of the foregoing, and any combination thereof.

In some embodiments, the second monomer is formed from one of any of the foregoing carboxylic acids, a salt thereof, or a conjugate base thereof. For example, the first monomer may include a carboxylate (e.g., dicarboxylate) of any of the foregoing carboxylic acids. Carboxylic acid salts may include lithium, beryllium, sodium, magnesium, potassium, calcium, zinc, etc., salts.

Suitable sulfonated acids may include 2-acrylamido-2-methylpropane sulfonic acid (ATBS), sulfostyrene, vinylsulfonic acid, methallylsulfonic acid, allylsulfonic acid, a salt of the foregoing (e.g., sodium methallyl sulfonate or ATBS sodium salts), or a conjugate base of the foregoing (e.g., methallyl sulfonate).

An alkylated molecule or residue thereof (e.g., alkylated acrylamide(s)) comprises at least one hydrophobic moiety, such as an alkyl group of one or more carbons. Suitable alkylated molecules may include N-tert-butylacrylamide, N-isopropylacrylamide, butoxymethylacrylamide, N,N-dimethylacrylamide, N,N-diethylacrylamide, dimethylamino ethyl methacrylate acid salts (including, but not limited to, sulfuric acid and hydrochloride acid salts), N-vinylpyrrolidone, analogues of any of the foregoing, residues of any of the foregoing, or any other molecule suitable for radical polymerization and being substantially as hydrophobic as the preceding examples.

In some embodiments, the alkylated molecule is an alkyl-acrylamide compound selected from the group consisting of N-butyl acrylamide, N,N′-dimethylaminopropylmethacrylic acid, methacrylamide, N-tertbutylacrylamide, N-isopropylacrylamide, butoxymethylacrylamide, N,N-dimethylacrylamide, N,N-diethylacrylamide, ethylene glycol dimethacrylate, hydroxymethylacrylate, hydroxyethylacrylate, hydroxypropylacrylate, hydroxypropylmethacrylate, diethylene glycol dimethacrylate, triethylene glycol dimethylacrylate, polyethylene glycol dimethacrylate, glycidyl methacrylate, N-vinylpyrrolidone, and any combination thereof.

In some embodiments, the second monomer comprises maleic anhydride, maleic acid, a partially neutralized product thereof, or a salt thereof, and the third monomer comprises acrylic acid.

In some embodiments, the second monomer comprises maleic anhydride and the third monomer comprises acrylic acid.

In some embodiments, the first, second, and third monomers are different.

In some embodiments, a method is provided for inhibiting calcium carbonate scale in a papermaking process, which can include adding an effective amount of a composition comprising a terpolymer to an aqueous medium in the papermaking process, wherein the terpolymer comprises about 40 mol % to about 60 mol % maleic anhydride, maleic acid, a partially neutralized product thereof, or a salt thereof, about 20 mol % to about 40 mol % acrylic acid, and about 5 mol % to about 50 mol % methacrylic acid; and inhibiting calcium carbonate scale in the papermaking process.

In some embodiments, the composition consists essentially of the terpolymer or consists of the terpolymer.

In certain embodiments, the methods disclosed herein may also inhibit calcium oxalate, calcium sulfate, sodium carbonate, sodium sulfate, and/or barium sulfate scale formation.

### BRIEF DESCRIPTION OF THE FIGURES

FIG. 1 depicts average % inhibition data for polymers of maleic anhydride and acrylic acid and for terpolymers of maleic anhydride, acrylic acid and methacrylic acid.

FIG. 2 depicts % inhibition data for terpolymer compositions of 50 mol % maleic anhydride, 30 mol % acrylic acid and 20% methacrylic acid.

FIG. 3 depicts % inhibition data for polymers of maleic anhydride and acrylic acid and for terpolymers of 50 mol % maleic anhydride, 30 mol % acrylic acid, and 20 mol % methacrylic acid.

FIG. 4 depicts % inhibition data for polymers of varying molecular weight.

FIG. 5 depicts % inhibition data for polymers of varying molecular weight.

FIG. 6 depicts % inhibition data for polymers of varying molecular weight.

### DETAILED DESCRIPTION

Unless otherwise defined, all technical and scientific terms used herein have the same meaning as commonly understood by one of ordinary skill in the art. In case of conflict, the present document, including definitions, will control. Examples of methods and materials are described below, although methods and materials similar or equivalent to those described herein can be used in practice or testing of the present disclosure. All publications, patent applications, patents and other reference materials mentioned herein are incorporated by reference in their entirety. The materials, methods, and examples disclosed herein are illustrative only and not intended to be limiting.

Unless otherwise indicated, an alkyl group as described herein alone or as part of another group is an optionally substituted linear or branched saturated monovalent hydrocarbon substituent containing from, for example, one to about sixty carbon atoms, such as one to about thirty carbon atoms, in the main chain. Examples of unsubstituted alkyl groups include methyl, ethyl, n-propyl, i-propyl, n-butyl, i-butyl, s-butyl, t-butyl, n-pentyl, i-pentyl, s-pentyl, t-pentyl, and the like.

Compounds, monomers, and/or polymers of the present disclosure may be substituted with suitable substituents. The term “suitable substituent,” as used herein, is intended to mean a chemically acceptable functional group, preferably a moiety that does not negate the activity of the compounds. Such suitable substituents include, but are not limited to, halo groups, perfluoroalkyl groups, perfluoro-alkoxy groups, alkyl groups, alkenyl groups, alkynyl groups, hydroxy groups, oxo groups, mercapto groups, alkylthio groups, alkoxy groups, aryl or heteroaryl groups, aryloxy or heteroaryloxy groups, aralkyl or heteroaralkyl groups, aralkoxy or heteroaralkoxy groups, HO—(C═O)— groups, heterocylic groups, cycloalkyl groups, amino groups, alkyl- and dialkylamino groups, carbamoyl groups, alkylcarbonyl groups, alkoxycarbonyl groups, alkylaminocarbonyl groups, dialkylamino carbonyl groups, arylcarbonyl groups, aryloxy-carbonyl groups, alkylsulfonyl groups, and arylsulfonyl groups. In some embodiments, suitable substituents may include halogen, an unsubstituted C₁-C₁₂ alkyl group, an unsubstituted C₄-C₆ aryl group, or an unsubstituted C₁-C₁₀ alkoxy group. Those skilled in the art will appreciate that many substituents can be substituted by additional substituents.

The term “substituted” as in “substituted alkyl,” means that in the group in question (i.e., the alkyl group), at least one hydrogen atom bound to a carbon atom is replaced with one or more substituent groups, such as hydroxy (—OH), alkylthio, phosphino, amido (—CON(R_{A})(R_{B}), wherein R_{A} and R_{B} are independently hydrogen, alkyl, or aryl), amino (—N(R_{A})(R_{B}), wherein R_{A} and R_{B} are independently hydrogen, alkyl, or aryl), halo (fluoro, chloro, bromo, or iodo), silyl, nitro (—NO₂), an ether (—OR_{A} wherein R_{A} is alkyl or aryl), an ester (—OC(O)R_{A} wherein R_{A} is alkyl or aryl), keto (—C(O) R_{A} wherein R_{A} is alkyl or aryl), heterocyclo, and the like.

When the term “substituted” introduces a list of possible substituted groups, it is intended that the term apply to every member of that group. That is, the phrase “optionally substituted alkyl or aryl” is to be interpreted as “optionally substituted alkyl or optionally substituted aryl.”

The terms “polymer,” “copolymer,” “polymerize,” “copolymerize,” and the like include not only polymers comprising two monomer residues and polymerization of two different monomers together, but also include (co)polymers comprising more than two monomer residues and polymerizing together more than two or more other monomers. For example, a polymer as disclosed herein includes a terpolymer, a tetrapolymer, polymers comprising more than four different monomers, as well as polymers comprising, consisting of, or consisting essentially of two different monomer residues. Additionally, a “polymer” as disclosed herein may also include a homopolymer, which is a polymer comprising a single type of monomer unit.

Unless specified differently, the polymers of the present disclosure may be linear, branched, crosslinked, structured, synthetic, semi-synthetic, natural, and/or functionally modified. A polymer of the present disclosure can be in the form of a solution, a dry powder, a liquid, or a dispersion, for example.

The term “pulp slurry” means a mixture comprising a liquid medium, such as water, within which solids, such as fibers (for example cellulose fibers) and optionally fillers, are dispersed or suspended such that between about >99% to about 45% by mass of the slurry is liquid medium. The portion of the papermaking process prior to the press section where a liquid medium, such as water, comprises more than about 45% of the mass of the substrate is referred to as the “wet end.” Conversely, the term “dry end” refers to that portion of the papermaking process including and subsequent to the press section where a liquid medium, such as water, typically comprises less than about 45% of the mass of the substrate. The compositions and methods disclosed herein can be incorporated into or carried out in the “wet end” and/or “dry end” of the papermaking process.

The term “sizing agent” refers to any additive that provides water-holdout to a composition of the present disclosure. Conventional papermaking sizing agents include rosin-based products, alkenyl succinic anhydrides, alkyl ketene dimers, styrene-maleic anhydride copolymers, styrene-acrylate and methacrylate copolymers, polyurethanes, wax emulsions, wax dispersions or a mixture thereof. The selection and amount of sizing agent can depend on the specific end-use requirements of the paper and/or paperboard products and is within the purview of a person of ordinary skill in the art of papermaking.

The paper manufacturing process can be organized into different general sections. For example, one section includes the location where a pulp slurry is disposed as thin layer on a moving papermaking wire or forming fabric. Another section is commonly referred to as the “press section,” which is where the thin layer is pressed to remove additional water. Following that is the dryer section where the pressed layer moves through a series of heated rollers. At this point, the dry substrate can be rewetted by passing it through a size press and further dried by passing it through another set of heated rollers. Finally, the dried substrate passes through a paper finishing section, such as a calendaring section (see, for example, Handbook for Pulp and Paper Technologists, 3rd Edition, by Gary A. Smook, Angus Wilde Publications Inc., (2002) and The Nalco Water Handbook (3rd Edition), by Daniel Flynn, McGraw Hill (2009)). The compositions and methods disclosed herein can be incorporated into or carried out in any of the foregoing sections.

The present disclosure provides compositions and methods for inhibiting calcium carbonate scaling during papermaking processes. The compositions and methods disclosed herein may also inhibit calcium oxalate, calcium sulfate, sodium carbonate, sodium sulfate, and/or barium sulfate scale formation.

In some embodiments, a method is provided for inhibiting calcium carbonate scale in a papermaking process, which can include adding an effective amount of a composition comprising a terpolymer to an aqueous medium in the papermaking process and inhibiting calcium carbonate scale. The terpolymer may comprise a weight average molecular weight of about 5,000 Da to about 20,000 Da. In some embodiments, the terpolymer comprises a first monomer comprising methacrylic acid, a second monomer comprising maleic anhydride, maleic acid, a partially neutralized product thereof, or a salt thereof, and a third monomer comprising acrylic acid.

The present disclosure also provides methods for inhibiting calcium carbonate scale in a papermaking process, which include adding an effective amount of a composition comprising a terpolymer to an aqueous medium in the papermaking process and inhibiting calcium carbonate scale. The terpolymer may comprise about 40 mol % to about 60 mol % maleic anhydride, maleic acid, a partially neutralized product thereof, or a salt thereof, about 20 mol % to about 40 mol % acrylic acid, and about 5 mol % to about 50 mol % methacrylic acid.

In any of the foregoing embodiments, it should be understood that maleic anhydride can be replaced with maleic acid, a partially neutralized product thereof, such as monosodium maleate and/or disodium maleate, and a salt thereof.

In any of the foregoing embodiments, the aqueous medium can be present in any section of the pulp or papermaking process. In any of the foregoing embodiments, a kraft paper digester, a black liquor evaporator, a recovery operation (such as, by way of example, but not limitation, a green liquor line, white liquor line or scrubber line), or a bleach plant may comprise the aqueous medium.

In any of the foregoing embodiments, the terpolymer may have a weight average molecular weight from about 5,000 Da to about 20,000 Da. By way of example, but not limitation, the terpolymer can have a weight average molecular weight from about 5,000 Da to about 20,000 Da, about 5,000 Da to about 19,000 Da, about 5,000 Da to about 18,000 Da, about 5,000 Da to about 17,000 Da, about 5,000 Da to about 16,000 Da, about 5,000 Da to about 15,000 Da, about 5,000 Da to about 14,000 Da, about 5,000 Da to about 13,000 Da, about 5,000 Da to about 12,000 Da, about 5,000 Da to about 11,000 Da, about 5,000 Da to about 10,000 Da, about 5,000 Da to about 9,000 Da, about 5,000 Da to about 8,000 Da, about 5,000 Da to about 7,000 Da, about 5,000 Da to about 6,000 Da, about 6,000 Da to about 20,000 Da, about 6,000 Da to about 19,000 Da, about 6,000 Da to about 18,000 Da, about 6,000 Da to about 17,000 Da, about 6,000 Da to about 16,000 Da, about 6,000 Da to about 15,000 Da, about 6,000 Da to about 14,000 Da, about 6,000 Da to about 13,000 Da, about 6,000 Da to about 12,000 Da, about 6,000 Da to about 11,000 Da, about 6,000 Da to about 10,000 Da, about 6,000 Da to about 9,000 Da, about 6,000 Da to about 8,000 Da, about 6,000 Da to about 7,000 Da, about 7,000 Da to about 20,000 Da, about 7,000 Da to about 19,000 Da, about 7,000 Da to about 18,000 Da, about 7,000 Da to about 17,000 Da, about 7,000 Da to about 16,000 Da, about 7,000 Da to about 15,000 Da, about 7,000 Da to about 14,000 Da, about 7,000 Da to about 13,000 Da, about 7,000 Da to about 12,000 Da, about 7,000 Da to about 11,000 Da, about 7,000 Da to about 10,000 Da, about 7,000 Da to about 9,000 Da, about 7,000 Da to about 8,000 Da, about 8,000 Da to about 20,000 Da, about 8,000 Da to about 19,000 Da, about 8,000 Da to about 18,000 Da, about 8,000 Da to about 17,000 Da, about 8,000 Da to about 16,000 Da, about 8,000 Da to about 15,000 Da, about 8,000 Da to about 14,000 Da, about 8,000 Da to about 13,000 Da, about 8,000 Da to about 12,000 Da, about 8,000 Da to about 11,000 Da, about 8,000 Da to about 10,000 Da, about 8,000 Da to about 9,000 Da, about 9,000 Da to about 20,000 Da, about 9,000 Da to about 19,000 Da, about 9,000 Da to about 18,000 Da, about 9,000 Da to about 17,000 Da, about 9,000 Da to about 16,000 Da, about 9,000 Da to about 15,000 Da, about 9,000 Da to about 14,000 Da, about 9,000 Da to about 13,000 Da, about 9,000 Da to about 12,000 Da, about 9,000 Da to about 11,000 Da, about 9,000 Da to about 10,000 Da, about 10,000 Da to about 20,000 Da, about 10,000 Da to about 19,000 Da, about 10,000 Da to about 18,000 Da, about 10,000 Da to about 17,000 Da, about 10,000 Da to about 16,000 Da, about 10,000 Da to about 15,000 Da, about 10,000 Da to about 14,000 Da, about 10,000 Da to about 13,000 Da, about 10,000 Da to about 12,000 Da, about 10,000 Da to about 11,000 Da, about 11,000 Da to about 20,000 Da, about 11,000 Da to about 19,000 Da, about 11,000 Da to about 18,000 Da, about 11,000 Da to about 17,000 Da, about 11,000 Da to about 16,000 Da, about 11,000 Da to about 15,000 Da, about 11,000 Da to about 14,000 Da, about 11,000 Da to about 13,000 Da, about 11,000 Da to about 12,000 Da, about 12,000 Da to about 20,000 Da, about 12,000 Da to about 19,000 Da, about 12,000 Da to about 18,000 Da, about 12,000 Da to about 17,000 Da, about 12,000 Da to about 16,000 Da, about 12,000 Da to about 15,000 Da, about 12,000 Da to about 14,000 Da, about 12,000 Da to about 13,000 Da, about 13,000 Da to about 20,000 Da, about 13,000 Da to about 19,000 Da, about 13,000 Da to about 18,000 Da, about 13,000 Da to about 17,000 Da, about 13,000 Da to about 16,000 Da, about 13,000 Da to about 15,000 Da, about 13,000 Da to about 14,000 Da, about 14,000 Da to about 20,000 Da, about 14,000 Da to about 19,000 Da, about 14,000 Da to about 18,000 Da, about 14,000 Da to about 17,000 Da, about 14,000 Da to about 16,000 Da, about 14,000 Da to about 15,000 Da, about 15,000 Da to about 20,000 Da, about 15,000 Da to about 19,000 Da, about 15,000 Da to about 18,000 Da, about 15,000 Da to about 17,000 Da, about 15,000 Da to about 16,000 Da, about 16,000 Da to about 20,000 Da, about 16,000 Da to about 19,000 Da, about 16,000 Da to about 18,000 Da, about 16,000 Da to about 17,000 Da, about 17,000 Da to about 20,000 Da, about 17,000 Da to about 19,000 Da, about 17,000 Da to about 18,000 Da, about 18,000 Da to about 20,000 Da, about 18,000 Da to about 19,000 Da, about 19,000 Da to about 20,000 Da, or about 5,000 Da, about 6,000 Da, about 7,000 Da, about 8,000 Da, about 9,000 Da, about 10,000 Da, about 11,000 Da, about 12,000 Da, about 13,000 Da, about 14,000 Da, about 15,000 Da, about 16,000 Da, about 17,000 Da, about 18,000 Da, about 19,000 Da, or about 20,000 Da.

In some embodiments, the terpolymer comprises a weight average molecular weight from about 6,000 Da to about 10,000 Da, from about 6,000 Da to about 9,000 Da, or from about 6,000 Da to about 8,000 Da.

In any of the foregoing embodiments, the terpolymer may comprise from about 40 mol % to about 60 mol % maleic anhydride, maleic acid, a partially neutralized product thereof, or a salt thereof. By way of example, but not limitation, the terpolymer may comprise from about 40 mol % to about 60 mol %, about 40 mol % to about 55 mol %, about 40 mol % to about 50 mol %, or about 40 mol % to about 45 mol % of the maleic anhydride, maleic acid, a partially neutralized product thereof, or a salt thereof, such as about 40 mol %, about 45 mol %, about 50 mol %, about 55 mol %, or about 60 mol % maleic anhydride, maleic acid, a partially neutralized product thereof, or a salt thereof.

In any of the foregoing embodiments, the terpolymer may comprise from about 20 mol % to about 40 mol % acrylic acid. By way of example, but not limitation, the terpolymer may comprise from about 20 mol % to about 40 mol %, about 20 mol % to about 35 mol %, about 20 mol % to about 30 mol %, about 20 mol % to about 25 mol %, about 25 mol % to about 40 mol %, about 25 mol % to about 35 mol %, about 25 mol % to about 30 mol %, about 30 mol % to about 40 mol % about 30 mol % to about 35 mol %, about 35 mol % to about 40 mol %, or about 20 mol %, about 25 mol %, about 30 mol %, about 35 mol %, or about 40 mol % acrylic acid.

In any of the foregoing embodiments, the terpolymer may comprise from about 5 mol % to about 50 mol % methacrylic acid. By way of example, but not limitation, the terpolymer may comprise from about 5 mol % to about 50 mol %, about 10 mol % to about 50 mol %, about 15 mol % to about 50 mol %, about 20 mol % to about 50 mol %, about 25 mol % to about 50 mol %, about 30 mol % to about 50 mol %, about 35 mol % to about 50 mol %, about 40 mol % to about 50 mol %, about 45 mol % to about 50 mol %, about 5 mol % to about 35 mol %, about 10 mol % to about 45 mol %, about 15 mol % to about 45 mol %, about 20 mol % to about 45 mol %, about 25 mol % to about 45 mol %, about 30 mol % to about 45 mol %, about 35 mol % to about 45 mol %, about 40 mol % to about 45 mol %, about 5 mol % to about 40 mol %, about 10 mol % to about 40 mol %, about 15 mol % to about 40 mol %, about 20 mol % to about 40 mol %, about 25 mol % to about 40 mol %, about 30 mol % to about 40 mol %, about 35 mol % to about 40 mol %, about 5 mol % to about 35 mol %, about 10 mol % to about 35 mol %, about 15 mol % to about 35 mol %, about 20 mol % to about 35 mol %, about 25 mol % to about 35 mol %, about 30 mol % to about 35 mol %, about 5 mol % to about 30 mol %, about 10 mol % to about 30 mol %, about 15 mol % to about 30 mol %, about 20 mol % to about 30 mol %, about 25 mol % to about 30 mol %, about 5 mol % to about 25 mol %, about 10 mol % to about 25 mol %, about 15 mol % to about 25 mol %, about 20 mol % to about 25 mol %, about 5 mol % to about 20 mol %, about 10 mol % to about 20 mol %, about 15 mol % to about 20 mol %, about 5 mol % to about 15 mol %, about 10 mol % to about 15 mol %, about 5 mol % to about 10 mol %, about 5 mol %, about 10 mol %, about 15 mol %, about 20 mol % about 25 mol %, about 30 mol % about 35 mol %, about 40 mol %, about 45 mol %, or about 50 mol %.

In some embodiments, the terpolymer comprises a first monomer comprising methacrylic acid in the amounts described above, a second monomer and a third monomer. The second and third monomers may be independently selected from, for example, an alkyl acrylic acid, a butenoic acid, such as crotonic acid, a pentenoic acid, a propenoic acid, an unsaturated monocarboxylic acid capable of polymerizing, a dicarboxylic acid, maleic anhydride, maleic acid, a partially neutralized product thereof, fumaric acid, itaconic acid, glutaconic acid, muconic acid, succinic acid, an unsaturated dicarboxylic acid, an anhydride of an unsaturated dicarboxylic acid capable of polymerizing, a compound containing three or more carboxylic acid groups, such as citric acid, aconitic acid, a monomer comprising a carboxyl moiety, a salt of any of the foregoing, a conjugate base of any of the foregoing, and any combination thereof.

In some embodiments, the second monomer is formed from one of any of the foregoing carboxylic acids, a salt thereof, or a conjugate base thereof. For example, the first monomer may include a carboxylate (e.g., dicarboxylate) of any of the foregoing carboxylic acids. Carboxylic acid salts may include lithium, beryllium, sodium, magnesium, potassium, calcium, zinc, etc., salts.

Suitable sulfonated acids may include ATBS, sulfostyrene, vinylsulfonic acid, methallylsulfonic acid, allylsulfonic acid, a salt of the foregoing (e.g., sodium methallyl sulfonate or ATBS sodium salts), or a conjugate base of the foregoing (e.g., methallyl sulfonate).

An alkylated molecule or residue thereof (e.g., alkylated acrylamide(s)) comprises at least one hydrophobic moiety, such as an alkyl group of one or more carbons. Suitable alkylated molecules may include N-tert-butylacrylamide, N-isopropylacrylamide, butoxymethylacrylamide, N,N-dimethylacrylamide, N,N-diethylacrylamide, dimethylamino ethyl methacrylate acid salts (including, but not limited to, sulfuric acid and hydrochloride acid salts), N-vinylpyrrolidone, analogues of any of the foregoing, residues of any of the foregoing, or any other molecule suitable for radical polymerization and being substantially as hydrophobic as the preceding examples.

In some embodiments, the second monomer comprises maleic anhydride, maleic acid, a partially neutralized product thereof, or a salt thereof, and the third monomer comprises acrylic acid.

In some embodiments, the second monomer comprises maleic anhydride, maleic acid, a partially neutralized product thereof, or a salt thereof and the third monomer comprises acrylic acid.

In some embodiments, the first, second, and third monomers are different.

In certain embodiments, the terpolymer is a polymer of CAS No. 67785-62-0 or CAS No. 105218-87-9.

The amount of second monomer in the terpolymer may range from, for example, about 40 mol % to about 60 mol %, about 40 mol % to about 55 mol %, about 40 mol % to about 50 mol %, or about 40 mol % to about 45 mol % of the maleic anhydride, maleic acid, a partially neutralized product thereof, or a salt thereof, such as about 40 mol %, about 45 mol %, about 50 mol %, about 55 mol %, or about 60 mol %.

The amount of third monomer in the terpolymer may range from, for example, about 20 mol % to about 40 mol %, about 20 mol % to about 35 mol %, about 20 mol % to about 30 mol %, about 20 mol % to about 25 mol %, about 25 mol % to about 40 mol %, about 25 mol % to about 35 mol %, about 25 mol % to about 30 mol %, about 30 mol % to about 40 mol % about 30 mol % to about 35 mol %, about 35 mol % to about 40 mol %, or about 20 mol %, about 25 mol %, about 30 mol %, about 35 mol %, or about 40 mol %.

In some embodiments, the composition comprising the terpolymer excludes cationic monomers and/or cationic polymers. In certain embodiments, the terpolymer excludes cationic monomers and/or cationic polymers.

In some embodiments, the composition comprising the terpolymer excludes a phosphate and/or a polyphosphate. In certain embodiments, the terpolymer excludes a phosphate and/or a polyphosphate.

In some embodiments, the compositions of the present disclosure may include additional papermaking additives including, but not limited to, strength agents, fillers, retention aids, optical brighteners, pigments, sizing agents, starch, dewatering agents, microparticles, coagulants, enzymes, and any combination thereof.

The compositions disclosed herein may be aqueous compositions comprising a pH from about 1 to about 14, such as from about 1 to about 12, from about 1 to about 10, from about 1 to about 8, from about 1 to about 6, from about 1 to about 4, from about 2 to about 14, from about 4 to about 14, from about 6 to about 14, from about 8 to about 14, from about 10 to about 14, or from about 12 to about 14. In certain embodiments, the composition comprises a pH of about 2, about 3, about 4, about 5, about 6, about 7, about 8, about 9, about 10, about 11, about 12, about 13, or about 14.

In any of the methods disclosed herein, the effective amount of the composition to be added to the aqueous medium is from about 0.25 kg to about 2 kg per ton of wood chips. For example, the effective amount may be from about 0.25 kg to about 1.75 kg, about 0.25 kg to about 1.5 kg, about 0.25 kg to about 1.25 kg, about 0.25 kg to about 1 kg, about 0.25 kg to about 0.75 kg, about 0.25 kg to about 0.5 kg, about 0.5 kg to about 0.75 kg, about 0.5 kg to about 1 kg, about 0.5 kg to about 1.25 kg, about 0.5 kg to about 1.5 kg, about 0.5 kg to about 1.75 kg, about 0.5 kg to about 2 kg, about 0.75 kg to about 1 kg, about 0.75 kg to about 1.25 kg, about 0.75 kg to about 1.5 kg, about 0.75 kg to about 1.75 kg, about 0.75 kg to about 2 kg, about 1 kg to about 1.25 kg, about 1 kg to about 1.5 kg, about 1 kg to about 1.75 kg, or about 1 kg to about 2 kg per ton of wood chips.

In some embodiments of the present disclosure, the composition may contain from about 10 wt. % to about 60 wt. % of the terpolymer expressed as the acid form of the terpolymer. For example, the composition may include from about 10 wt. % to about 50 wt. %, from about 10 wt. % to about 40 wt. %, from about 10 wt. % to about 30 wt. %, from about 10 wt. % to about 20 wt. %, from about 20 wt. % to about 60 wt. %, from about 20 wt. % to about 50 wt. %, from about 20 wt. % to about 40 wt. %, from about 20 wt. % to about 30 wt. %, from about 30 wt. % to about 60 wt. %, from about 30 wt. % to about 50 wt. %, or from about 30 wt. % to about 40 wt. % of the terpolymer. In certain embodiments, the composition may comprise about 20 wt. %, about 25 wt. %, about 30 wt. %, about 35 wt. %, or about 40 wt. % of the terpolymer.

### Examples

All amounts for monomers in the examples are given as mol % of the terpolymer.

Synthetic black liquor samples containing a commercial alkaline lignin sample, sodium hydroxide and sodium carbonate (pH about 13) were prepared and about 100 ppm of calcium chloride was added thereto. A test article was also added to each sample followed by mixing. Once mixed, a small sample was collected for blank calcium measurement and the remaining sample was kept in an eight-vessel lab scale digester for about one hour with a temperature increase from about 56° C. to about 170° C. After about one hour, samples were collected and filtered through a 0.45 μm syringe filter. Test articles were prepared by extracting 10 mL of liquor samples from the autoclave before and after the cooking process. The samples were then passed through a 0.45 micron size syringe filter. The liquor that passed through the filter was attributed to the inhibition. A polymer including about a ratio of about 50:50 maleic anhydride:acrylic acid was used as a control.

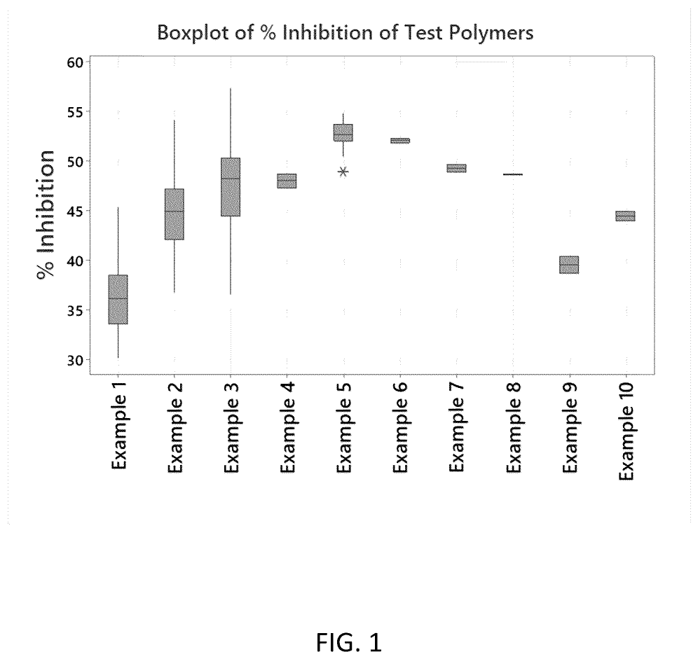

Samples were then analyzed for calcium using the inductively coupled plasma technique on an inductively coupled plasma optical emissions system (ICP_OES) by standard techniques with results presented as % inhibition, which was calculated by using total calcium measured in the sample after one hour divided by the initial amount of calcium in the solution (blank sample). Results are shown in FIG. 1 and in Table 1 below. In Table 1 below, MA refers to methacrylic acid, AA refers to acrylic acid, and MAH refers to maleic anhydride. 10% MA (40 MAH) refers to a 40:50:10 mixture of MAH:AA:MA while 20% MA (40 MAH) refers to a 40:40:20 mixture of MAH:AA:MA. In FIG. 1, the percentage refers to the amount of MA substituted for acrylic acid in a 50:50 MAH:AA mixture.

TABLE 1
Percent Inhibition Data with Variable
Amounts of Methacrylic Acid

| | Average | | |
|---|---|---|---|
| | % | | Standard |
| Sample | Inhibition | Count | Deviation |
| Example | 35.46 | 47 | 3.25 |
| 1: 50:50 | | | |
| MAH:AA | | | |
| Example | 43.03 | 65 | 4.51 |
| 2: 50:50 | | | |
| MAH:AA | | | |
| Example | 47.78 | 34 | 4.57 |
| 3: 50:40:10 | | | |
| MAH:AA:MA | | | |
| Example | 47.95 | 2 | 0.72 |
| 4: 50:35:15 | | | |
| MAH:AA:MA | | | |
| Example | 52.41 | 24 | 1.51 |
| 5: 50:30:20 | | | |
| MAH:AA:MA | | | |
| Example | 51.98 | 2 | 0.21 |
| 6: 50:29:21 | | | |
| MAH:AA:MA | | | |
| Example | 49.22 | 2 | 0.37 |
| 7: 50:20:30 | | | |
| MAH:AA:MA | | | |
| Example | 48.58 | 2 | 0.02 |
| 8: 50:50 | | | |
| MAH:MA | | | |
| Example | 39.49 | 2 | 0.86 |
| 9: 40:50:10 | | | |
| MAH:AA:MA | | | |
| Example | 44.41 | 2 | 0.51 |
| 10: 40:40:20 | | | |
| MAH:AA:MA | | | |

The foregoing exemplary preparations were made as follows:

Polymer Example 1 (about 50 mol % MAH, about 50 mol % AA; weight average molecular weight about 11,000 Da): Deionized water (about 221 g), iron sulfate (about 0.025 g) and maleic anhydride (about 169 g, 1.459 mol) were added to a 1.5 liter reactor vessel with overhead paddle stirring, a nitrogen inlet, and a condenser. A 50% NaOH solution (about 249 g) was added slowly by pipet to the reactor while stirring, heating to about 95° C., and purging with nitrogen gas. An initiator solution of sodium persulfate (“SPS”) (about 12 g, 0.052 mol) in 30% aqueous hydrogen peroxide (about 87 g) was prepared by stirring. A monomer solution of acrylic acid (about 124 g, 1.727 mol), and water (about 92 g) was prepared by stirring. Two semi-batch feeds were prepared for addition to the reactor. The SPS/HOOH initiator solution was added to the reactor over 200 minutes, the acrylic acid monomer solution was added to the reactor over 180 minutes. Both feeds were started simultaneously, and the SPS/HOOH initiator feed ran for 20 min after the completion of the monomer feed. After completion of the initiator feed at ˜200 min elapsed, the reaction mixture was held at about 95° C. with stirring for 30 min, cooled to RT, and a 50% NaOH solution (about 55 g) was added to the reactor before disassembly and characterization.

Polymer Example 2 (about 50 mol % MAH, about 50 mol % AA; weight average molecular weight about 8,300 Da): Deionized water (about 221 g), iron sulfate (about 0.25 g) and maleic anhydride (about 170 g, 1.459 mol) were added to a 1.5 liter reactor vessel with overhead paddle stirring, a nitrogen inlet, and a condenser. A 50% NaOH solution (about 249 g) was added slowly by pipet to the reactor while stirring, heating to about 95° C., and purging with nitrogen gas. An initiator solution of SPS (about 12 g, 0.052 mol) in 30% aqueous hydrogen peroxide (about 87 g) was prepared by stirring. A monomer solution of acrylic acid (about 124 g, 1.727 mol), and water (about 92 g) was prepared by stirring. Two semi-batch feeds were prepared for addition to the reactor. The SPS/HOOH initiator solution was added to the reactor over 200 minutes, the acrylic acid monomer solution was added to the reactor over 180 minutes. Both feeds were started simultaneously, and the SPS/HOOH initiator feed ran for 20 min after the completion of the monomer feed. After completion of the initiator feed at ˜200 min elapsed, the reaction mixture was held at about 95° C. with stirring for 30 min, cooled to RT, and a 50% NaOH solution (about 55 g) was added to the reactor before disassembly and characterization.

Polymer Example 3 (about 50 mol % MAH, about 40 mol % AA, about 10 mol % MA; weight average molecular weight about 8,800 Da): Deionized water (about 221 g), iron sulfate (about 0.25 g) and maleic anhydride (about 169 g, 1.459 mol) were added to a 1.5 liter reactor vessel with overhead paddle stirring, a nitrogen inlet, and a condenser. A 50% NaOH solution (about 249 g) was added slowly by pipet to the reactor while stirring, heating to about 95° C., and purging with nitrogen gas. An initiator solution of SPS) (about 12 g, 0.052 mol) in 30% aqueous hydrogen peroxide (about 87 g) was prepared by stirring. A monomer solution of acrylic acid (about 100 g, 1.382 mol), methacrylic acid (about 30 g, 0.346 mol) and water (about 92 g) was prepared by stirring. Two semi-batch feeds were prepared for addition to the reactor. The SPS/HOOH initiator solution was added to the reactor over 200 minutes, the acrylic acid/methacrylic acid monomer solution was added to the reactor over 180 minutes. Both feeds were started simultaneously, and the SPS/HOOH initiator feed ran for 20 min after the completion of the monomer feed. After completion of the initiator feed at ˜200 min elapsed, the reaction mixture was held at about 95° C. with stirring for 30 min, cooled to RT, and a 50% NaOH solution (about 55 g) was added to the reactor before disassembly and characterization.

Polymer Example 4 (about 50 mol % MAH, about 35 mol % AA, about 15 mol % MA; weight average molecular weight about 8,600 Da): Deionized water (about 221 g), iron sulfate (about 0.25 g) and maleic anhydride (about 169 g, 1.459 mol) were added to a 1.5 liter reactor vessel with overhead paddle stirring, a nitrogen inlet, and a condenser. A 50% NaOH solution (about 249 g) was added slowly by pipet to the reactor while stirring, heating to about 95° C., and purging with nitrogen gas. An initiator solution of SPS (about 12 g, 0.052 mol) in 30% aqueous hydrogen peroxide (about 87 g) was prepared by stirring. A monomer solution of acrylic acid (about 87 g, 1.209 mol), methacrylic acid (about 45 g, 0.518 mol) and water (about 107 g) was prepared by stirring. Two semi-batch feeds were prepared for addition to the reactor. The SPS/HOOH initiator solution was added to the reactor over 200 minutes, the acrylic acid/methacrylic acid monomer solution was added to the reactor over 180 minutes. Both feeds were started simultaneously, and the SPS/HOOH initiator feed ran for 20 min after the completion of the monomer feed. After completion of the initiator feed at ˜200 min elapsed, the reaction mixture was held at about 95° C. with stirring for 30 min, cooled to RT, and a 50% NaOH solution (about 55 g) was added to the reactor before disassembly and characterization.

Polymer Example 5 (about 50 mol % MAH, about 30 mol % AA, about 20 mol % MA; weight average molecular weight about 8,400 Da): Deionized water (about 221 g), iron sulfate (about 0.25 g) and maleic anhydride (about 169 g, 1.459 mol) were added to a 1.5 liter reactor vessel with overhead paddle stirring, a nitrogen inlet, and a condenser. A 50% NaOH solution (about 249 g) was added slowly by pipet to the reactor while stirring, heating to about 95° C., and purging with nitrogen gas. An initiator solution of SPS (about 12 g, 0.052 mol) in 30% aqueous hydrogen peroxide (about 87 g) was prepared by stirring. A monomer solution of acrylic acid (about 75 g, 1.036 mol), methacrylic acid (about 59 g, 0.691 mol) and water (about 113 g) was prepared by stirring. Two semi-batch feeds were prepared for addition to the reactor. The SPS/HOOH initiator solution was added to the reactor over 200 minutes, the acrylic acid/methacrylic acid monomer solution was added to the reactor over 180 minutes. Both feeds were started simultaneously, and the SPS/HOOH initiator feed ran for 20 min after the completion of the monomer feed. After completion of the initiator feed at ˜200 min elapsed, the reaction mixture was held at about 95° C. with stirring for 30 min, cooled to RT, and a 50% NaOH solution (about 55 g) was added to the reactor before disassembly and characterization.

Polymer Example 6 (about 50 mol % MAH, about 29 mol % AA, about 21 mol % MA; weight average molecular weight about 8,000 Da): Deionized water (about 221 g), iron sulfate (about 0.25 g) and maleic anhydride (about 169 g, 1.459 mol) were added to a 1.5 liter reactor vessel with overhead paddle stirring, a nitrogen inlet, and a condenser. A 50% NaOH solution (about 249 g) was added slowly by pipet to the reactor while stirring, heating to about 95° C., and purging with nitrogen gas. An initiator solution of SPS (about 12 g, 0.052 mol) in 30% aqueous hydrogen peroxide (about 87 g) was prepared by stirring. A monomer solution of acrylic acid (about 72 g, 1.000 mol), methacrylic acid (about 62 g, 0.725 mol) and water (about 133 g) was prepared by stirring. Two semi-batch feeds were prepared for addition to the reactor. The SPS/HOOH initiator solution was added to the reactor over 200 minutes, the acrylic acid/methacrylic acid monomer solution was added to the reactor over 180 minutes. Both feeds were started simultaneously, and the SPS/HOOH initiator feed ran for 20 min after the completion of the monomer feed. After completion of the initiator feed at ˜200 min elapsed, the reaction mixture was held at about 95° C. with stirring for 30 min, cooled to RT, and a 50% NaOH solution (about 55 g) was added to the reactor before disassembly and characterization.

Polymer Example 7 (about 50 mol % MAH, about 20 mol % AA, about 30 mol % MA; weight average molecular weight about 8,300 Da): Deionized water (about 221 g), iron sulfate (about 0.25 g) and maleic anhydride (about 169 g, 1.459 mol) were added to a 1.5 liter reactor vessel with overhead paddle stirring, a nitrogen inlet, and a condenser. A 50% NaOH solution (about 249 g) was added slowly by pipet to the reactor while stirring, heating to about 95° C., and purging with nitrogen gas. An initiator solution of SPS (about 12 g, 0.052 mol) in 30% aqueous hydrogen peroxide (about 87 g) was prepared by stirring. A monomer solution of acrylic acid (about 50 g, 0.691 mol), methacrylic acid (about 89 g, 1.036 mol) and water (about 121 g) was prepared by stirring. Two semi-batch feeds were prepared for addition to the reactor. The SPS/HOOH initiator solution was added to the reactor over 200 minutes, the acrylic acid/methacrylic acid monomer solution was added to the reactor over 180 minutes. Both feeds were started simultaneously, and the SPS/HOOH initiator feed ran for 20 min after the completion of the monomer feed. After completion of the initiator feed at ˜200 min elapsed, the reaction mixture was held at about 95° C. with stirring for 30 min, cooled to RT, and a 50% NaOH solution (55 g) was added to the reactor before disassembly and characterization.

Polymer Example 8 (about 50 mol % MAH, about 50 mol % MA; weight average molecular weight about 9,500 Da): Deionized water (about 221 g), iron sulfate (about 0.25 g) and maleic anhydride (about 169 g, 1.459 mol) were added to a 1.5 liter reactor vessel with overhead paddle stirring, a nitrogen inlet, and a condenser. A 50% NaOH solution (about 249 g) was added slowly by pipet to the reactor while stirring, heating to about 95° C., and purging with nitrogen gas. An initiator solution of SPS (about 12 g, 0.052 mol) in 30% aqueous hydrogen peroxide (about 87 g) was prepared by stirring. A monomer solution of methacrylic acid (about 149 g, 1.728 mol) and water (about 142 g) was prepared by stirring. Two semi-batch feeds were prepared for addition to the reactor. The SPS/HOOH initiator solution was added to the reactor over 200 minutes, the acrylic acid/methacrylic acid monomer solution was added to the reactor over 180 minutes. Both feeds were started simultaneously, and the SPS/HOOH initiator feed ran for 20 min after the completion of the monomer feed. After completion of the initiator feed at ˜200 min elapsed, the reaction mixture was held at about 95° C. with stirring for 30 min, cooled to RT, and a 50% NaOH solution (about 55 g) was added to the reactor before disassembly and characterization.

Polymer Example 9 (about 40 mol % MAH, about 50 mol % AA, about 10 mol % MA; weight average molecular weight about 9,100 Da): Deionized water (about 221 g), iron sulfate (about 0.25 g) and maleic anhydride (about 136 g, 1.167 mol) were added to a 1.5 liter reactor vessel with overhead paddle stirring, a nitrogen inlet, and a condenser. A 50% NaOH solution (about 199 g) was added slowly by pipet to the reactor while stirring, heating to about 95° C., and purging with nitrogen gas. An initiator solution of SPS (about 12 g, 0.052 mol) in 30% aqueous hydrogen peroxide (about 87 g) was prepared by stirring. A monomer solution of acrylic acid (about 125 g, 1.728 mol), methacrylic acid (about 30 g, 0.346 mol) and water (about 115 g) was prepared by stirring. Two semi-batch feeds were prepared for addition to the reactor. The SPS/HOOH initiator solution was added to the reactor over 200 minutes, the acrylic acid/methacrylic acid monomer solution was added to the reactor over 180 minutes. Both feeds were started simultaneously, and the SPS/HOOH initiator feed ran for 20 min after the completion of the monomer feed. After completion of the initiator feed at ˜200 min elapsed, the reaction mixture was held at about 95° C. with stirring for 30 min, cooled to RT, and a 50% NaOH solution (about 55 g) was added to the reactor before disassembly and characterization.

Polymer Example 10 (about 40 mol % MAH, about 40 mol % AA, about 20 mol % MA; weight average molecular weight about 9,100 Da): Deionized water (about 221 g), iron sulfate (about 0.25 g) and maleic anhydride (about 136 g, 1.167 mol) were added to a 1.5 liter reactor vessel with overhead paddle stirring, a nitrogen inlet, and a condenser. A 50% NaOH solution (about 199 g) was added slowly by pipet to the reactor while stirring, heating to about 95° C., and purging with nitrogen gas. An initiator solution of SPS (about 12 g, 0.052 mol) in 30% aqueous hydrogen peroxide (about 87 g) was prepared by stirring. A monomer solution of acrylic acid (about 99 g, 1.382 mol), methacrylic acid (about 60 g, 0.691 mol) and water (about 125 g) was prepared by stirring. Two semi-batch feeds were prepared for addition to the reactor. The SPS/HOOH initiator solution was added to the reactor over 200 minutes, the acrylic acid/methacrylic acid monomer solution was added to the reactor over 180 minutes. Both feeds were started simultaneously, and the SPS/HOOH initiator feed ran for 20 min after the completion of the monomer feed. After completion of the initiator feed at ˜200 min elapsed, the reaction mixture was held at about 95° C. with stirring for 30 min, cooled to RT, and a 50% NaOH solution (about 55 g) was added to the reactor before disassembly and characterization.

These results demonstrate that the control provides inhibition values of about 35% when MA is substituted in the polymer composition for a portion of the AA at certain molecular weights. A polymer comprising about 50:30:20 MAH:AA:MA was the best performing in this experiment. The results demonstrated that adding more MA beyond 20 mol % may have diminishing returns and an eventually a negative effect on scale inhibition performance.

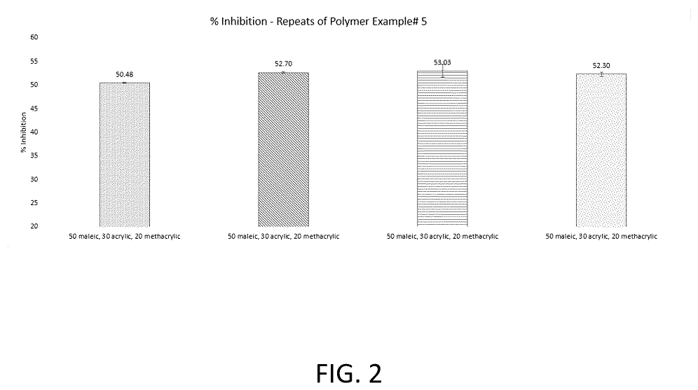

Similar experiments were carried out with different samples including a terpolymer of about 50:30:20 MAH:AA:MA. The weight average molecular weight of the terpolymer varied in each sample. As can be seen in FIG. 2, the composition comprising the inventive terpolymer consistently shows scale inhibition of greater than 50% in lab performance testing. The weight average molecular weight of each polymer tested, from left to right in FIG. 2, was about 8,400 Da, about 8,600 Da, about 8,600 Da, and about 8,700 Da.

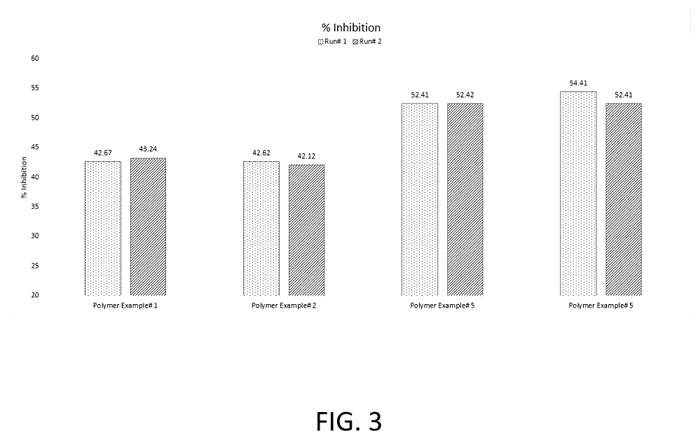

Similar experiments were carried out with different batches of 50:50 MAH:AA versus about 50:30:20 MAH:AA:MA. The polymers of each sample were of comparable molecular weights (about 8,000 Da to about 9,000 Da). The results are shown in FIG. 3. As can be seen, the composition comprising the inventive terpolymer consistently outperforms the control composition (50:50 MAH:AA).

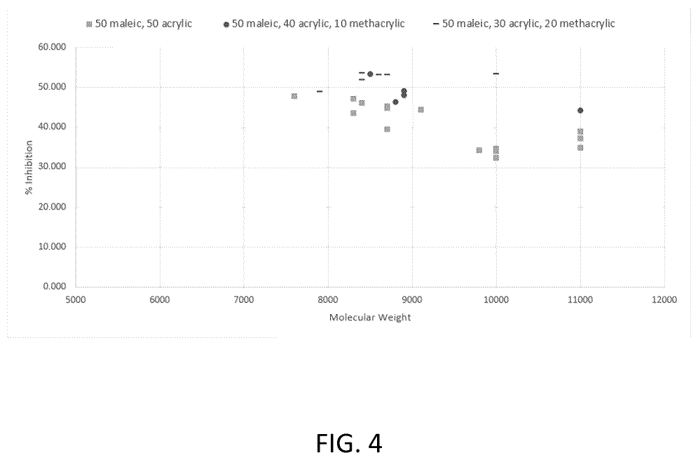

Additional experiments were carried out using 50:50 MAH:AA, about 50:40:10 MAH:AA:MA, and about 50:30:20 MAH:AA:MA at various molecular weights. The results shown in FIG. 4 demonstrate that the three-component terpolymer compositions outperform the control composition.

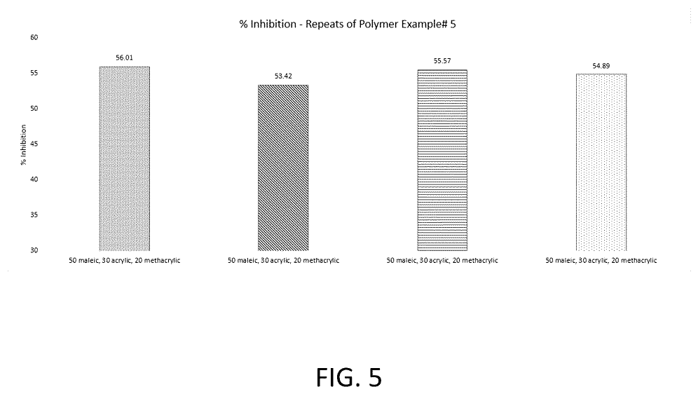

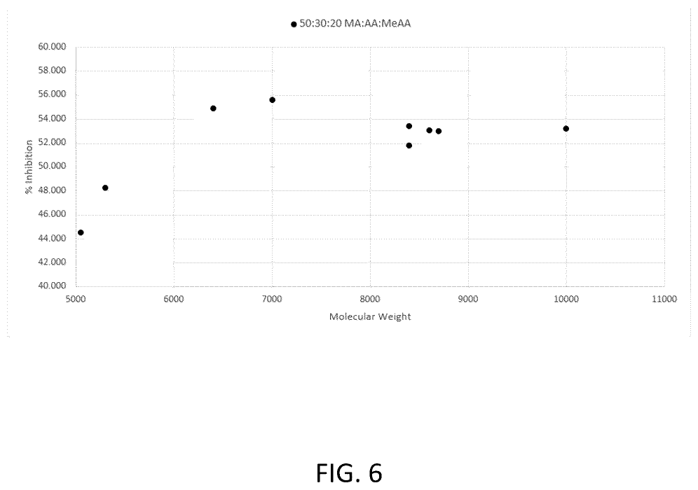

The experiment was repeated with about 50:30:20 MAH:AA:MA at varying molecular weights as shown in FIGS. 5 and 6. In FIG. 5, the polymer of the first column had a weight average molecular weight of about 8,700 Da, the polymer of the second column had a weight average molecular weight of about 7,900 Da, the polymer of the third column had a weight average molecular weight of about 7,000 Da, and the polymer of the fourth column had a weight average molecular weight of about 6,400 Da. As can be seen in FIG. 6, there is a drop off in % inhibition below about 6,000 Da.

All of the compositions and methods disclosed and claimed herein can be made and executed without undue experimentation in light of the present disclosure. While this invention may be embodied in many different forms, there are described in detail herein specific preferred embodiments of the invention. The present disclosure is an exemplification of the principles of the invention and is not intended to limit the invention to the particular embodiments illustrated. In addition, unless expressly stated to the contrary, use of the term “a” is intended to include “at least one” or “one or more.” For example, “a monomer” is intended to include “at least one monomer” or “one or more monomers.”

Any ranges given either in absolute terms or in approximate terms are intended to encompass both, and any definitions used herein are intended to be clarifying and not limiting. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all subranges (including all fractional and whole values) subsumed therein.

Any composition disclosed herein may comprise, consist of, or consist essentially of any element, component and/or ingredient disclosed herein or any combination of two or more of the elements, components or ingredients disclosed herein.

Any method disclosed herein may comprise, consist of, or consist essentially of any method step disclosed herein or any combination of two or more of the method steps disclosed herein.

The transitional phrase “comprising,” which is synonymous with “including,” “containing,” or “characterized by,” is inclusive or open-ended and does not exclude additional, un-recited elements, components, ingredients and/or method steps.

The transitional phrase “consisting of” excludes any element, component, ingredient, and/or method step not specified in the claim.

The transitional phrase “consisting essentially of” limits the scope of a claim to the specified elements, components, ingredients and/or steps, as well as those that do not materially affect the basic and novel characteristic(s) of the claimed invention.

Unless specified otherwise, all molecular weights referred to herein are weight average molecular weights and all viscosities were measured at 25° C. with neat (not diluted) polymers.

As used herein, the term “about” refers to the cited value being within the errors arising from the standard deviation found in their respective testing measurements, and if those errors cannot be determined, then “about” may refer to, for example, within 5%, 4%, 3%, 2%, or 1% of the cited value.

Furthermore, the invention encompasses any and all possible combinations of some or all of the various embodiments described herein. It should also be understood that various changes and modifications to the presently preferred embodiments described herein will be apparent to those skilled in the art. Such changes and modifications can be made without departing from the spirit and scope of the invention and without diminishing its intended advantages. It is therefore intended that such changes and modifications be covered by the appended claims.

What is claimed is:

1. A method for inhibiting calcium carbonate scale in a papermaking process, comprising:
adding an effective amount of a composition comprising a terpolymer to an aqueous medium in the papermaking process, wherein the terpolymer comprises:
about 5 mol % to about 50 mol % of a first monomer, the first monomer comprising methacrylic acid or a salt thereof,
about 40 mol % to about 60 mol % of a second monomer, and
about 20 mol % to about 40 mol % of a third monomer; and
inhibiting calcium carbonate scale in the papermaking process.

2. The method of claim 1, wherein a kraft paper digester, a black liquor, a recovery operation, a green liquor line, a white liquor line, a scrubber line, or a bleach plant evaporator comprises the aqueous medium.

3. The method of claim 1, wherein the terpolymer has a weight average molecular weight from about 5,000 Da to about 20,000 Da.

4. The method of claim 1, wherein the effective amount is from about 0.25 kg to about 2 kg per ton of wood chips.

5. The method of claim 1, wherein the second and the third monomers are independently selected from the group consisting of an alkyl acrylic acid, a butenoic acid, a pentenoic acid, a propenoic acid, an unsaturated monocarboxylic acid, a dicarboxylic acid, maleic anhydride, maleic acid, monosodium maleate, disodium maleate, fumaric acid, itaconic acid, glutaconic acid, muconic acid, succinic acid, an unsaturated dicarboxylic acid, an anhydride of an unsaturated dicarboxylic acid, a compound containing three or more carboxylic acid groups, a monomer comprising a carboxyl moiety, a salt of any of the foregoing, a conjugate base of any of the foregoing, and any combination thereof.

6. The method of claim 1, wherein the second monomer comprises maleic anhydride, maleic acid, monosodium maleate, disodium maleate, or a salt thereof.

7. The method of claim 1, wherein the second monomer comprises maleic anhydride, maleic acid, monosodium maleate, disodium maleate, or a salt of any of the foregoing, and the third monomer comprises acrylic acid or a salt thereof.

8. The method of claim 1, wherein the terpolymer comprises about 50 mol % maleic anhydride, maleic acid, monosodium maleate, or a salt thereof, about 30 mol % acrylic acid or a salt thereof, and about 20 mol % methacrylic acid or a salt thereof.

9. A method for inhibiting calcium carbonate scale in a papermaking process, comprising:
adding an effective amount of a composition comprising a terpolymer to an aqueous medium in the papermaking process, wherein the terpolymer has a weight average molecular weight of about 5,000 Da to about 20,000 Da, further wherein the terpolymer comprises a first monomer comprising methacrylic acid or a salt thereof, a second monomer, and a third monomer; and
inhibiting calcium carbonate scale in the papermaking process.

10. The method of claim 9, wherein the terpolymer comprises from about 15 mol % to about 25 mol % methacrylic acid or a salt thereof.

11. The method of claim 9, wherein a kraft paper digester, a black liquor, a recovery operation, a green liquor line, a white liquor line, a scrubber line, or a bleach plant evaporator comprises the aqueous medium.

12. The method of claim 9, wherein the second and the third monomers are independently selected from the group consisting of an alkyl acrylic acid, a butenoic acid, a pentenoic acid, a propenoic acid, an unsaturated monocarboxylic acid, a dicarboxylic acid, maleic anhydride, maleic acid, monosodium maleate, disodium maleate, fumaric acid, itaconic acid, glutaconic acid, muconic acid, succinic acid, an unsaturated dicarboxylic acid, an anhydride of an unsaturated dicarboxylic acid, a compound containing three or more carboxylic acid groups, a monomer comprising a carboxyl moiety, a salt of any of the foregoing, a conjugate base of any of the foregoing, and any combination thereof.

13. The method of claim 9, wherein the second monomer comprises maleic anhydride, maleic acid, a partially neutralized product thereof, or a salt thereof.

14. The method of claim 9, wherein the second monomer comprises maleic anhydride, maleic acid, monosodium maleate, disodium maleate, or a salt thereof, and the third monomer comprises acrylic acid or a salt thereof.

15. The method of claim 9, wherein the terpolymer comprises about 50 mol % maleic anhydride, maleic acid, monosodium maleate, disodium maleate, or a salt thereof, about 30 mol % acrylic acid or a salt thereof, and about 20 mol % methacrylic acid or a salt thereof.

16. The method of claim 9, wherein the composition comprising the terpolymer does not contain a cationic component.

17. The method of claim 9, wherein the composition comprising the terpolymer does not contain a polyphosphonate.

18. The method of claim 9, wherein the composition consists essentially of the terpolymer.

19. The method of claim 9, wherein the composition consists of the terpolymer.

20. The method of claim 9, wherein the method further inhibits calcium oxalate, calcium sulfate, sodium carbonate, sodium sulfate, and/or barium sulfate scale formation.
